(19) United States
(12) Patent Application Publication
(10) Pub. No.: US 2021/0365167 A1
(43) Pub. Date: Nov. 25, 2021

(54) TOUCH PANEL WITH THIN SIDE FRAME AND RELATED MANUFACTURING METHOD THEREOF

(71) Applicant: WUHAN CHINA STAR OPTOELECTRONICS SEMICONDUCTOR DISPLAY TECHNOLOGY CO,, LTD., Wuhan (CN)

(72) Inventor: Weiguo YOU, Wuhan (CN)

(73) Assignee: WUHAN CHINA STAR OPTOELECTRONICS SEMICONDUCTOR DISPLAY TECHNOLOGY CO,, LTD., Wuhan (CN)

(21) Appl. No.: 16/468,012

(22) PCT Filed: Mar. 7, 2019
(86) PCT No.: PCT/CN2019/077280

§ 371 Date: Jun. 10, 2019

(30) Foreign Application Priority Data
Dec. 25, 2018 (CN) 201811586981.7

(51) Int. Cl. G06F 3/041; G06F 3/044

(52) U.S. Cl. CPC G06F 3/04164; G06F 2203/04103; G06F 3/044

(57) ABSTRACT

A touch panel and a manufacturing method for the touch panel are provided. The touch panel can reduce the width of the side frame occupied by the circuit wires by arranging the circuit wires one after another with the insulating layer between them, utilizing via holes within the insulating layer to connect the circuit wires of different layers. Thus, the demand of narrow side frame could be met.

### FIELD OF THE INVENTION

The present disclosure relates to a touch panel, and more particularly, to a touch panel with a thin side frame.

### BACKGROUND

The demands for thinner side frame increase along with the development of smart phones of full-screen and high screen share. A full-screen smart phone with a thin side frame becomes normal. The smart phone manufacturers keep themselves innovative due to the high competition in this field. In a conventional smart phone, a block wall structure is formed at left and right sides and upper and lower ends of backlight support under the touch panel (for example, using a soft printed circuit board to connect related components, such as sensors of front camera) such that the size of side frame, which belongs to a non-viewable region, is increased. The width of the non-viewable region of the touch panel influences the width of the side frame.

A conventional cell phone has a wider side frame because of the block wall structure. In general, the width of the side frame is about 3 mm and thus the screen-to-body ratio is smaller. However, the consumer has a higher demand on cell phones having higher screen-to-body ratio and super narrow side frame. Therefore, the structure of the touch panel needs to be improved.

Please refer to FIG. 1, which is a diagram showing a conventional structure of circuit wires in the side frame of the touch panel. The conventional circuit wires are arranged in one side and arranged in a matrix of a fixed pitch. The width of the side frame is limited by the limit of the lithography process (minimum line width). As shown in FIG. 1, the pitch 18 between 13, 14 and 15 surrounding the viewable region 12 is determined by the minimum line width of the lithography process. In other words, if the side frame needs to include N wires, the side frame at least needs to be the product of N and the pitch 18. In this way, the width of the side frame of the touch panel cannot be effectively reduced.

Therefore, a new touch panel should be provided to meet the demands of high screen-to-body ratio and super narrow side frame.

### SUMMARY

The technical issue that a preferred embodiment of the present disclosure solves is to provide a touch panel to meet the demand of high screen-to-body ratio and super narrow side frame outside the viewable area of the touch panel.

According to a first embodiment of the present disclosure, a touch panel is disclosed. The touch panel comprises a plurality of upper layer circuit wires and a plurality of lower layer circuit wires corresponding to the upper layer circuit wires; at least one ITO channel; a plurality of binding electrodes; and a plurality of via holes, configured to electrically connect the upper layer circuit wires to the lower layer circuit wires, electrically connect the upper layer circuit wires to the ITO channel, electrically connect the upper layer circuit wires to the binding electrodes; or electrically connect the lower layer circuit wires to the binding electrodes; wherein the upper layer circuit wires and the lower layer circuit wires are arranged one after another with at least one insulating layer between them, the via holes are arranged within the insulating layer to directly connect the lower circuit wires to the ITO channel.

According to the first embodiment of the present disclosure, the touch panel is a capacitor-type touch panel.

According to the first embodiment of the present disclosure, the upper layer circuit wires, the lower layer circuit wires and the via holes are made by metal material.

According to the first embodiment of the present disclosure, the upper layer circuit wires, the lower layer circuit wires, and the via holes that connect the upper layer circuit wires to the lower layer circuit wires are made by metal material, and the via holes that connect the upper layer circuit wires to the ITO channel are made by ITO material.

According to a second embodiment of the present disclosure, a circuit wire manufacturing method of a touch panel is disclosed. The touch panel comprises: a plurality of upper layer circuit wires and a plurality of lower layer circuit wires corresponding to the upper layer circuit wires; at least one ITO channel in an ITO layer; a plurality of binding electrodes; and a plurality of via holes, configured to electrically connect the upper layer circuit wires to the lower layer circuit wires, electrically connect the upper layer circuit wires to the ITO channel, electrically connect the upper layer circuit wires to the binding electrodes; or electrically connect the lower layer circuit wires to the binding electrodes; wherein the upper layer circuit wires and the lower layer circuit wires are arranged one after another with at least one insulating layer between them, the via holes are arranged within the insulating layer to directly connect the lower circuit wires to the ITO channel. The manufacturing method comprises: utilizing a first mask to perform a patterning process of the ITO layer; utilizing a second mask to perform a patterning process of the lower layer circuit wires; utilizing a third mask to perform a patterning process of the via holes the lower layer metal wires and the upper layer circuit wires; utilizing fourth mask to perform a patterning process of the upper layer circuit wires; utilizing a fifth mask to perform a patterning process of ITO bridging via holes of the first ITO channel; and utilizing a sixth mask to perform a patterning process of an ITO bridging circuit.

According to the second embodiment of the present disclosure, the upper layer circuit wires, the lower layer circuit wires and the via holes are made by metal material, and the ITO bridging circuit is made by ITO material.

According to the second embodiment of the present disclosure, the touch panel is a capacitor-type touch panel.

According to a third embodiment of the present disclosure, a circuit wire manufacturing method of a touch panel is provided. The touch panel comprises: a plurality of upper layer circuit wires and a plurality of lower layer circuit wires corresponding to the upper layer circuit wires; at least one Indium Tin oxide (ITO) channel in an ITO layer; a plurality of binding electrodes; and a plurality of via holes, configured to electrically connect the upper layer circuit wires to the lower layer circuit wires, electrically connect the upper layer circuit wires to the ITO channel, electrically connect the upper layer circuit wires to the binding electrodes; or electrically connect the lower layer circuit wires to the binding electrodes. The upper layer circuit wires and the lower layer circuit wires are arranged one after another with at least one insulating layer between them, the via holes are arranged within the insulating layer to directly connect the lower circuit wires to the ITO channel. The manufacturing method comprises: utilizing a first mask to perform a patterning process of the ITO layer; utilizing a second mask to perform a patterning process of the lower layer circuit wires; utilizing a third mask to perform a patterning process of the via holes the lower layer metal wires and the upper layer circuit wires; and utilizing fourth mask to perform a patterning process of a bridging circuit between the upper circuit wires and the ITO layer.

According to the third embodiment of the present disclosure, the upper layer circuit wires, the lower layer circuit wires and the via holes are made by metal material.

According to the third embodiment of the present disclosure, the touch panel is a capacitor-type touch panel.

The touch panel of an embodiment of the present disclosure can reduce the width of the side frame occupied by the circuit wires by arranging the circuit wires one after another with the insulating layer between them, utilizing via holes within the insulating layer to connect the circuit wires of different layers. Thus, the demand of narrow side frame could be met.

### BRIEF DESCRIPTION OF THE DRAWINGS

The accompanying drawings described herein are used to provide further comprehension of the present disclosure, and is a part of the present application. Schematic embodiments of the present disclosure and the description thereof are used to illustrate the present disclosure, but do not constitute any improper limit to the present disclosure. In the accompanying drawings:

FIG. 1 is a diagram showing a structure of circuit wires of a side frame of a conventional touch panel.

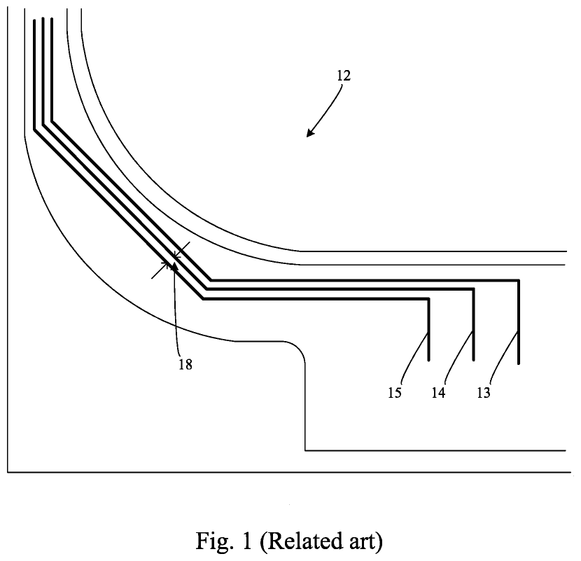

FIG. 2 is a diagram showing a structure of circuit wires of a side frame of a touch panel according to an embodiment of the present disclosure.

FIG. 3 is diagram showing the structure of circuit wires at the edge of a side frame of a touch panel according to an embodiment of the present disclosure.

FIG. 4 is a diagram showing a part of the structure of circuit wires of the side frame in a viewable area according to an embodiment of the present disclosure.

FIG. 5 is a diagram showing another part of the structure of the circuit wires of the side frame in the viewable area according to an embodiment of the present disclosure.

FIG. 6 is a diagram showing a structure of circuit wires of a side frame of a touch panel in a binding area according to an embodiment of the present disclosure.

### DETAILED DESCRIPTION OF PREFERRED EMBODIMENTS

To help a person skilled in the art better understand the solutions of the present disclosure, the following clearly and completely describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

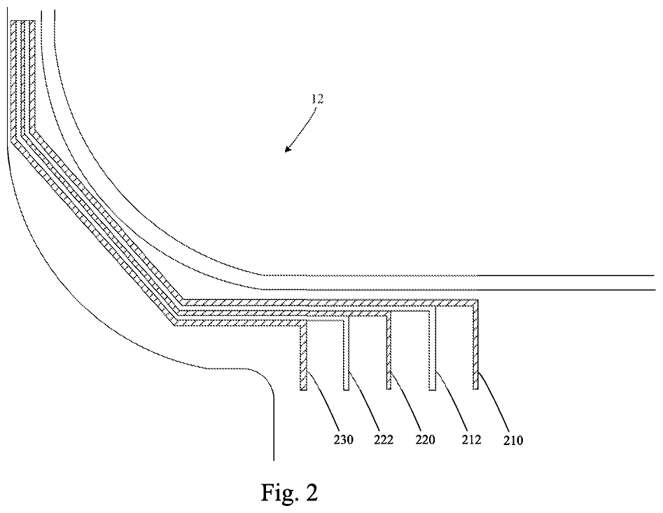

Please refer to FIG. 2. FIG. 2 is a diagram showing a structure of circuit wires of a side frame of a touch panel according to an embodiment of the present disclosure. As shown in FIG. 2, the side frame surrounding the viewable area 202 of the touch panel comprises a first upper layer circuit wire 210, a first lower layer circuit wire 212, a second upper layer circuit wire 220, a second lower layer circuit wire 222, and a third upper layer circuit wire 230. The first upper layer circuit wire 210 and the first lower layer circuit wire 212 are arranged one after another and isolated by an insulating layer. The second upper layer circuit wire 220 and the second lower layer circuit wire 222 are arranged one after another and isolated by an insulating layer. These circuit wires are adjacently arranged in a matrix. In this embodiment, the touch panel could be a capacitor-type touch panel.

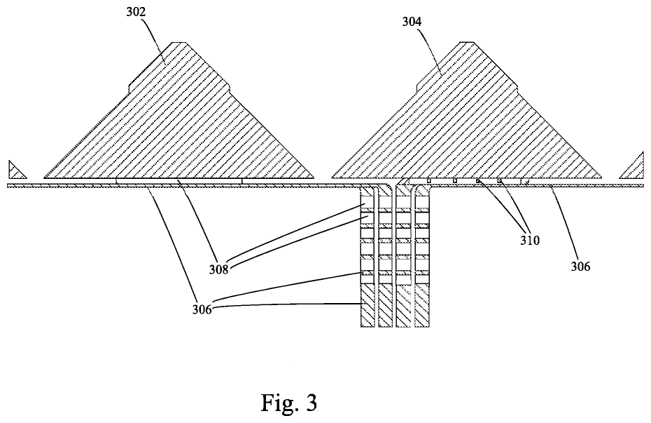

Please refer to FIG. 3. FIG. 3 is diagram showing the structure of circuit wires at the edge of a side frame of a touch panel according to an embodiment of the present disclosure. As shown in FIG. 3, at the edge of the viewable area 202, the touch panel comprises a first Indium Tin oxide (ITO) channel 302 and a second ITOT channel 304, a plurality of upper layer circuit wires 306, a plurality of lower layer circuit wires 308, and a plurality of via holes 310. The upper layer circuit wires 306 and the lower layer circuit wires 308 are arranged one after another and isolated by insulating layers at the edge of the viewable area 202. These circuit wires could be electrically connected to another circuit layer via the corresponding via holes 310. The insulating layers could be designed to have more layers such that more circuit wires are allowed to be overlapped with each other with the insulating layers between them. This could enormously reduce the width of the side frame occupied by the circuit wires.

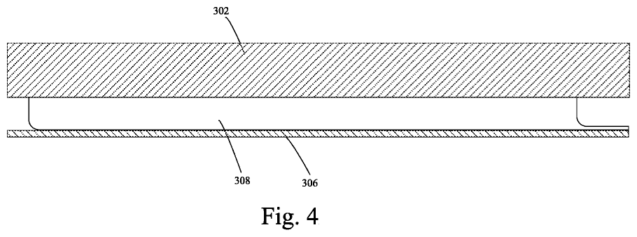

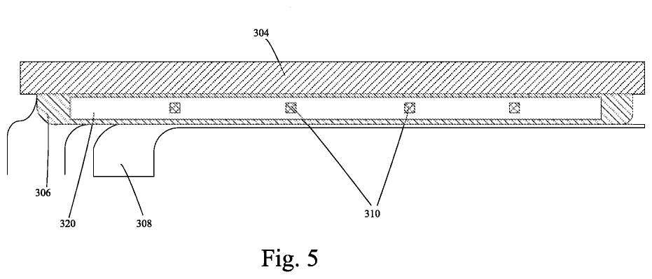

Please refer to FIG. 4 and FIG. 5. FIG. 4 is a diagram showing a part of the structure of circuit wires of the side frame in a viewable area according to an embodiment of the present disclosure. FIG. 5 is a diagram showing another part of the structure of the circuit wires of the side frame in the viewable area according to an embodiment of the present disclosure. At the edge of the viewable area of the touch panel, the lower circuit wire 308 could be directly electrically connected to the corresponding first ITO channel 302. In the region 320 at the edge of the viewable area of the touch panel, the upper layer circuit wire 306 is spacially overlapped and isolated with the lower layer circuit wire 308 and thus the upper layer circuit cannot be directly connected to the second ITO channel 304. Therefore, the upper layer circuit wire 306 could be electrically connected to the second ITO channel 304 through the corresponding via hole 310. Similarly, the lower layer circuit wire 308 cannot directly be connected to the first ITO channel 302 due to spacial limitations. The lower layer circuit wire 308 could be electrically connected to the first ITO channel 302 through the via hole 310 within the insulating layer.

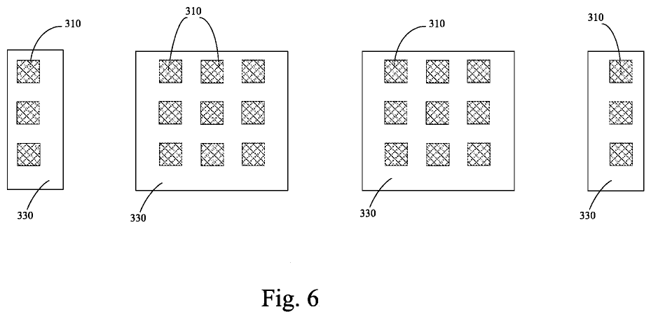

FIG. 6 is a diagram showing a structure of circuit wires of a side frame of a touch panel in a binding area according to an embodiment of the present disclosure. In the binding area 330 of the touch panel, the upper layer circuit wire 306, the lower layer circuit wire 308 and binding metal electrode (not shown) could be overlapped with each other. The upper layer circuit wire 306 can be electrically connected to the corresponding metal electrode through a corresponding via hole 310. The lower layer circuit wire 308 can be electrically connected to the corresponding metal electrode through a corresponding via hole 310. In this way, the width of the side frame occupied by the upper layer circuit wire 306, the lower layer circuit wire 308 and the binding metal electrode can be enormously reduced. This makes the circuit could be more efficiently arranged on the side frame.

According to an embodiment of the present disclosure, a circuit wire manufacturing method for a touch panel is disclosed. The circuit wire manufacturing method comprises:

Step 102: Utilize a first mask to perform a patterning process of the ITO layer.

Step 104: Utilize a second mask to perform a patterning process of a plurality of lower layer metal wires.

Step 106: Utilize a third mask to perform a patterning process of a plurality of via holes between two layers of metal wires.

Step 108: Utilize a fourth mask to perform a patterning process of a plurality of upper layer metal wires.

Step 110: Utilize a fifth mask to perform a patterning process of ITO bridging via holes of the first ITO channel in the viewable area of the touch panel.

Step 112: Utilize a sixth mask to perform a patterning process of an ITO bridging circuit of the second ITO channel in the viewable area of the touch panel.

In this embodiment, the bridging circuit in the viewable area of the touch panel is made by ITO material and thus six masks are used to complete the entire manufacturing processes.

In another embodiment of the present disclosure, a circuit wire manufacturing method for a touch panel is disclosed. The circuit wire manufacturing method comprises:

Step 202: Utilize a first mask to perform a patterning process of the ITO layer.

Step 204: Utilize a second mask to perform a patterning process of a plurality of lower layer metal wires.

Step 206: Utilize a third mask to perform a patterning process of ITO bridging via holes of the touch panel between two layers of metal wires.

Step 208: Utilize a fourth mask to perform a patterning process of upper layer metal wires and a metal bridging circuit in the viewable area of the touch panel.

In this embodiment, the bridging circuit in the viewable area of the touch panel is made by metal material. Therefore, the upper layer metal wires and the metal bridging circuit can share the same mask in the manufacturing process and four masks are used to complete the entire manufacturing process.

The touch panel of an embodiment of the present disclosure can reduce the width of the side frame occupied by the circuit wires by arranging the circuit wires one after another with the insulating layer between them, utilizing via holes within the insulating layer to connect the circuit wires of different layers. Thus, the demand of narrow side frame could be met. Further, the technique of an embodiment of the present disclosure can be used in the circuit wire design of the circuit wire of the side frame of an LCD panel or LED panel.

Above are embodiments of the present disclosure, which does not limit the scope of the present disclosure. Any modifications, equivalent replacements or improvements within the spirit and principles of the embodiment described above should be covered by the protected scope of the invention.

What is claimed is:

1. A touch panel, wherein a side frame of the touch panel comprises:
a plurality of upper layer circuit wires and a plurality of lower layer circuit wires corresponding to the upper layer circuit wires;
at least one Indium Tin oxide (ITO) channel;
a plurality of binding electrodes; and
a plurality of via holes, configured to electrically connect the upper layer circuit wires to the lower layer circuit wires, electrically connect the upper layer circuit wires to the ITO channel, electrically connect the upper layer circuit wires to the binding electrodes; or electrically connect the lower layer circuit wires to the binding electrodes;
wherein the upper layer circuit wires and the lower layer circuit wires are arranged one after another with at least one insulating layer between them, the via holes are arranged within the insulating layer to directly connect the lower circuit wires to the ITO channel.

2. The touch panel of claim 1, wherein the touch panel is a capacitor-type touch panel.

3. The touch panel of claim 1, wherein the upper layer circuit wires, the lower layer circuit wires and the via holes are made by metal material.

4. The touch panel of claim 1, wherein the upper layer circuit wires, the lower layer circuit wires, and the via holes that connect the upper layer circuit wires to the lower layer circuit wires are made by metal material, and the via holes that connect the upper layer circuit wires to the ITO channel are made by ITO material.

5. A circuit wire manufacturing method of a touch panel, wherein the touch panel comprises:
a plurality of upper layer circuit wires and a plurality of lower layer circuit wires corresponding to the upper layer circuit wires;
at least one Indium Tin oxide (ITO) channel in an ITO layer;
a plurality of binding electrodes; and
a plurality of via holes, configured to electrically connect the upper layer circuit wires to the lower layer circuit wires, electrically connect the upper layer circuit wires to the ITO channel, electrically connect the upper layer circuit wires to the binding electrodes; or
electrically connect the lower layer circuit wires to the binding electrodes;
wherein the upper layer circuit wires and the lower layer circuit wires are arranged one after another with at least one insulating layer between them, the via holes are arranged within the insulating layer to directly connect the lower circuit wires to the ITO channel;
the manufacturing method comprises:
utilizing a first mask to perform a patterning process of the ITO layer;
utilizing a second mask to perform a patterning process of the lower layer circuit wires;
utilizing a third mask to perform a patterning process of the via holes the lower layer metal wires and the upper layer circuit wires;
utilizing fourth mask to perform a patterning process of the upper layer circuit wires;
utilizing a fifth mask to perform a patterning process of ITO bridging via holes of the first ITO channel; and
utilizing a sixth mask to perform a patterning process of an ITO bridging circuit.

6. The manufacturing method of claim 5, wherein the upper layer circuit wires, the lower layer circuit wires and the via holes are made by metal material, and the ITO bridging circuit is made by ITO material.

7. The manufacturing method of claim 5, wherein the touch panel is a capacitor-type touch panel.

8. A circuit wire manufacturing method of a touch panel, wherein the touch panel comprises:
a plurality of upper layer circuit wires and a plurality of lower layer circuit wires corresponding to the upper layer circuit wires;
at least one Indium Tin oxide (ITO) channel in an ITO layer;
a plurality of binding electrodes; and
a plurality of via holes, configured to electrically connect the upper layer circuit wires to the lower layer circuit wires, electrically connect the upper layer circuit wires to the ITO channel, electrically connect the upper layer circuit wires to the binding electrodes; or electrically connect the lower layer circuit wires to the binding electrodes;
wherein the upper layer circuit wires and the lower layer circuit wires are arranged one after another with at least one insulating layer between them, the via holes are arranged within the insulating layer to directly connect the lower circuit wires to the ITO channel;
the manufacturing method comprises:
utilizing a first mask to perform a patterning process of the ITO layer
utilizing a second mask to perform a patterning process of the lower layer circuit wires;
utilizing a third mask to perform a patterning process of the via holes the lower layer metal wires and the upper layer circuit wires; and
utilizing fourth mask to perform a patterning process of a bridging circuit between the upper circuit wires and the ITO layer.

9. The manufacturing method of claim 8, wherein the upper layer circuit wires, the lower layer circuit wires and the via holes are made by metal material.

10. The manufacturing method of claim 8, wherein the touch panel is a capacitor-type touch panel.
